(19) United States
(12) Patent Application Publication
(10) Pub. No.: US 2024/0055152 A1
(43) Pub. Date: Feb. 15, 2024

(54) Conductive Film, Preparation Method thereof, Device Containing Conductive Film, and Ink Formulation

(71) Applicant: Najing Technology Corporation Limited, Hangzhou, Zhejiang (CN)

(72) Inventors: Xinyan GU, Hangzhou, Zhejiang (CN); Wenling AI, Hangzhou, Zhejiang (CN)

(21) Appl. No.: 18/265,982

(22) PCT Filed: Dec. 28, 2021
(86) PCT No.: PCT/CN2021/142144

§ 371 Date: Jun. 8, 2023

(30) Foreign Application Priority Data
Dec. 29, 2020 (CN) 202011597490.X
Dec. 29, 2020 (CN) 202011597517.5

(51) Int. Cl. H01B 5/14; C09D 11/52

(52) U.S. Cl. CPC H01B 5/14; C09D 11/52

(57) ABSTRACT

Disclosed is a conductive film, a preparation method thereof, a device containing the conductive film, and anink formulation. The conductive film includes a first conductive material and a second conductive material. The first conductive material includes first conductors and first ligands coating the surfaces of the first conductors. The second conductive material includes second conductors and second ligands coating the surfaces of the second conductors. And the first ligand and the second ligand have mutually exclusive affinities to water.

### CROSS-REFERENCE TO RELATED APPLICATIONS

This application is based on Chinese Patent Application No. 202011597490.X (filed Dec. 29, 2020) and Chinese Patent Application No. 202011597517.5 (filed Dec. 29, 2020), which claims the benefit of priority to the Chinese Patent Applications which are incorporated by reference in its entirety herein.

### TECHNICAL FIELD

The disclosure relates to the technical field of photo electricity, in particular to a conductive film, a preparation method thereof, a device containing the conductive film, and anink formulation.

### BACKGROUND

A silver nanowire refers to a one-dimensional silver material with the length in the micrometer scale and the diameter in the nanometer scale, and is considered to be a material which is most likely to replace a traditional IndiumTinOxide (ITO) transparent electrode. A film prepared by the silver nanowire has higher conductivity and transparency, and can be widely applied to the fields of touch control, display, illumination, photovoltaic and the like.

Due to the excellent conductivity of silver, the silver nanowire film manufactured by the existing method can realize smaller resistance, to meet the requirements of various products on the conductivity, but there is still much room for improvement in the light transmittance of the film. The transmittance of the conductive film depends on the distribution density, distribution uniformity, diameter and length of the silver nanowire, and when the silver nanowires are made of the same material (i.e., the same diameter and length), how to control the distribution density and uniformity of the silver nanowires becomes a key factor for affecting the light transmittance of the conductive film.

At present, two methods are mainly used for improving the transmittance of the conductive film, one is to control the volatility of a solvent of a silver wire suspension liquid in the manufacturing process of the conductive film so that the silver wire can be dried and precipitated at a relatively stable speed; the other is to dilute the silver wire solution to relatively low solid content and then manufacture the conductive film, and a method of repeating the manufacturing process for many times is utilized to meet the requirement of relatively low sheet resistance. However, the two methods have very limited improvement on the light transmittance of the conductive film, and the situation of excessive accumulation of silver wires in local areas is still very serious.

### SUMMARY

An objective of the disclosure is to provide a conductive film, which includes a first conductive material and a second conductive material, the first conductive material includes a first conductor and a first ligand coating the surface of the first conductor, the second conductive material includes a second conductor and a second ligand coating the surface of the second conductor, and the first ligand and the second ligand have mutually exclusive affinities to water.

Furthermore, the first conductor and the second conductor are metal nanowires.

Furthermore, the weight ratio of the first conductive material to the second conductive material is 1:10 to 10:1.

Furthermore, the mass of the first ligand accounts for 0.1% to 10% of the total mass of the first conductive material; and the mass of the second ligand accounts for 0.1% to 10% of the total mass of the second conductive material.

Furthermore, the metal nanowires are silver nanowires, the diameter of each silver nanowire is 10 to 100 nm, and the length of each silver nanowire is 10 to 100 μm.

Furthermore, the first ligand and the second ligand are respectively independently selected from one or more of a nanoparticle ligand, an organic small molecule ligand and a polymer ligand.

Furthermore, the nanoparticle ligand is an inorganic nanoparticle ligand or an organic nanoparticle ligand, the inorganic nanoparticle ligand is selected from at least one of inorganic salts, metal oxide particles, metal particles and SiO₂ nanospheres, and the organic nanoparticle ligand is selected from at least one of micelle microspheres and polymer microspheres.

Furthermore, the structural formula of the organic small molecule ligand is X-Y, X is used to coordinate with the surface of the first conductor or the second conductor, the structure of Y includes a hydrophilic group or a hydrophobic group, a hydrophobic group is selected from at least one of a saturated aliphatic group, an unsaturated aliphatic group, halogen, an aromatic hydrocarbon group, an ester group and a nitro group, and a hydrophobic group is selected from at least one of a saturated aliphatic group, an unsaturated aliphatic group, halogen, an aromatic hydrocarbon group, an ester group and a nitro group.

Furthermore, the polymer ligand is selected from one or more of PVP, PEO, PEG, FIB, PVK, PVB, PSS, cycloolefin copolymer and fluorine-containing resin.

Furthermore, a sheet resistance of the conductive film is ≤500 Ω/□.

Furthermore, the transmittance of the conductive film in the visible range is ≥70%.

The disclosure further provides a device containing any of the conductive films described above.

Furthermore, the device includes a first electrode, a functional layer and a second electrode which are sequentially stacked, and the first electrode and/or the second electrode include/includes the conductive film.

Furthermore, the functional layer has a first functional layer close to the first electrode and a second functional layer close to the second electrode, and the device has at least one of characteristic A and characteristic B: A, the conductive film of the first electrode and the first functional layer are embedded with each other; B, the conductive film of the second electrode and the second functional layer are embedded with each other.

Furthermore, the conductive film of the first electrode and/or the second electrode is disposed adjacent to the functional layer.

Furthermore, the first electrode is composed of the conductive film and a bottom electrode material.

Furthermore, the device includes a carrier transport layer, part of the material of the carrier transport layer is embedded in the conductive film, and part of the surface of the conductive film is covered by the carrier transport layer.

The disclosure further provides anink formulation, which includes a first ink and a second ink, the first ink includes a first conductive material and a first solvent, the second ink includes a second conductive material and a second solvent, the first conductive material includes a first conductor and a first ligand coating the surface of the first conductor, the second conductive material includes a second conductor and a second ligand coating the surface of the second conductor, and the first ligand and the second ligand have mutually exclusive affinities to water.

Furthermore, the solid content of the conductive material of the first ink and the second ink is independently 0.01 wt % to 10 wt %.

Furthermore, the mass of the first ligand accounts for 0.1% to 10% of the total mass of the first conductive material; and the mass of the second ligand accounts for 0.1% to 10% of the total mass of the second conductive material.

Furthermore, the weight ratio of the first conductive material to the second conductive material is 1:10 to 10:1.

Furthermore, the surface tension of the first ink is 30 to 70 mN/m, and the surface tension of the second ink is 20 to 40 mN/m.

Furthermore, the first conductor and the second conductor are metal nanowires.

Furthermore, the first ligand and the second ligand are respectively independently selected from one or more of a nanoparticle ligand, an organic small molecule ligand and a polymer ligand.

Furthermore, the nanoparticle ligand is an inorganic nanoparticle ligand or an organic nanoparticle ligand, the inorganic nanoparticle ligand is selected from at least one of inorganic salts, metal oxide particles, metal particles and SiO₂ nanospheres, and the organic nanoparticle ligand is selected from at least one of micelle microspheres and polymer microspheres.

Furthermore, the structural formula of the organic small molecule ligand is X-Y, X is used to coordinate with the surface of the first conductor or the second conductor, the structure of Y includes a hydrophilic group or a hydrophobic group, the hydrophilic group is selected from at least one of ahydroxyl group, acarboxyl group, analdehyde group, anamino group, anamine group, asulfonic group and asulfinyl group, and a hydrophobic group is selected from at least one of a saturated aliphatic group, an unsaturated aliphatic group, halogen, an aromatic hydrocarbon group, an ester group and a nitro group.

Furthermore, the polymer ligand is selected from one or more of PVP, PEO, PEG, FIB, PVK, PVB, PSS, cycloolefin copolymer and fluorine-containing resin.

Furthermore, the first ink and the second ink further include an additive, and the additive includes at least one of a viscosity regulator and a surface tension regulator.

The disclosure further provides a preparation method of a conductive film, which includes the following steps: S1, a substrate is provided; S2, a first ink is disposed on the substrate, and drying treatment is carried out to form a pre-conductive layer; S3, a second ink is disposed on the pre-conductive layer, and drying treatment is carried out; the first ink includes a first conductive material and a first solvent, the second ink includes a second conductive material and a second solvent, the first conductive material includes a first conductor and a first ligand coating the surface of the first conductor, the second conductive material includes a second conductor and a second ligand coating the surface of the second conductor, and the first ligand and the second ligand have mutually exclusive affinities to water.

Furthermore, S2 and S3 are repeated at least once after S3.

Furthermore, the solid content of the conductive material of the first ink and the second ink is independently 0.01 wt % to 10 wt %.

Furthermore, the mass of the first ligand accounts for 0.1% to 10% of the total mass of the first conductive material; and the mass of the second ligand accounts for 0.1% to 10% of the total mass of the second conductive material.

Furthermore, the surface tension of the first ink is 30 to 70 mN/m, and the surface tension of the second ink is 20 to 40 mN/m.

Furthermore, the first conductor and the second conductor are metal nanowires.

Furthermore, a sheet resistance of the conductive film is 500Ω/□; and the transmittance of the conductive film in the visible range is 70%.

With the application of the technical solution of the disclosure, in the process of preparing the conductive film, the surfaces of the first conductive material and the second conductive material have ligands with mutually exclusive affinities to water, then the area with a larger distribution density of the first conductive material can produce more repulsion to the second conductive material introduced later, which is beneficial for the second conductive material to deposit on the area where the distribution density of the original first conductive material is small or uncovered part of the substrate, so as to reduce the excessive stacking or aggregation of the conductive material and form conductive film with uniform distribution of the conductive material. The conductive film prepared by the above materials has the advantages of good conductivity and high light transmittance. The light transmittance of the device with the conductive film is improved.

### BRIEF DESCRIPTION OF THE DRAWINGS

FIG. 1, FIG. 3, and FIG. 5 are diagrams of 500 times magnification of microscope successively of an electroluminescent device in Examples 10, 11, and 12 of the disclosure.

FIG. 2, FIG. 4, and FIG. 6 are diagrams of 500 times magnification of microscope successively of an electroluminescent device in Comparative Examples 4, 5, and 6 of the disclosure.

### DETAILED DESCRIPTION OF THE EMBODIMENTS

It should be noted that the following detailed descriptions are illustrative and are intended to provide further explanation to the disclosure. Unless defined otherwise, all technical and scientific terms used herein have the same meaning as commonly understood by those of ordinary skill in the art to which this disclosure belongs.

It is to be noted that the terms “first,” “second,” and the like in the specification and the claims of the disclosure are used for distinguishing between similar objects and not necessarily for describing a particular sequence or sequential order. It is to be understood that data so used may be interchanged where appropriate so that the embodiments of the disclosure described herein can be implemented in other sequences than those illustrated or described herein. In addition, the terms “comprise” and “have” and any variations thereof, are intended to cover a non-exclusive inclusion, e.g., a process, method, system, product, or device that comprises a series of steps or units is not necessarily limited to those steps or units expressly listed, rather, other steps or units not expressly listed or inherent to such process, method, product, or device may be included.

The term “ligand” in this disclosure relates to a substance capable of coating the surface of a conductor in some form and is not limited to atoms, molecules and ions capable of forming bonds with the central atom (metal or metal-like) as generally understood by those of ordinary skill in the technical field. The term “exclusive affinities to water” can refer to the following evaluation criteria: the HLB value being equal to 10 defines the dividing line, and the affinities of ligands located on both sides of the dividing line are considered to be exclusive. When the HLB value is less than 10, it is generally hydrophobic (or lipophilic), when the HLB value is more than 10, it is generally hydrophilic, and the higher the HLB value, the stronger the hydrophilicity. Of course, the evaluation criteria of exclusive affinities to water can also refer to other indicators that can be used to evaluate the affinity of substances as understood by those skilled in the art, and are not limited to the above HLB value.

As described in the background, the uneven distribution of the conductive materials of the conductive film in the prior art results in low light transmittance. In order to solve the technical problems, in an aspect of the disclosure, a conductive film is provided, which includes a first conductive material and a second conductive material, the first conductive material includes first conductors and first ligands coating the surfaces of the first conductors, the second conductive material includes second conductors and second ligands coating the surfaces of the second conductors, and the first ligand and the second ligand have mutually exclusive affinities to water.

A plurality of first conductors and a plurality of second conductors are available. In the process of preparing the conductive film, the surfaces of the first conductive material and the second conductive material have ligands with mutually exclusive affinities to water, then the area with a larger distribution density of the first conductive material can produce more repulsion to the second conductive material introduced later, which is beneficial for the second conductive material to deposit on the area where the distribution density of the original first conductive material is small or uncovered part of the substrate, so as to reduce the excessive stacking or aggregation of the conductive material and form conductive film with uniform distribution of the conductive material. The conductive film prepared by the above materials has the advantages of good conductivity and high light transmittance.

In some embodiments, the first conductor and the second conductor are metal nanowires. In a preferred implementation mode, the first conductor and the second conductor are silver nanowires.

In some embodiments, the weight ratio of the first conductive material to the second conductive material in the conductive film is 1:10 to 10:1. In some embodiments, the weight ratio of the first conductive material to the second conductive material is 1:3 to 3:1. The concentrations of the first conductive material and the second conductive material are appropriately close, which is beneficial to the distribution uniformity of the conductive materials.

In order to take into account the conductivity of conductive film while improving the distribution uniformity of conductive materials, in some embodiments, the mass of the first ligand accounts for 0.1% to 10% of the total mass of the first conductive material; and the mass of the second ligand accounts for 0.1% to 10% of the total mass of the second conductive material. In some embodiments, the mass of the first ligand accounts for 0.5% to 5% of the total mass of the first conductive material; and the mass of the second ligand accounts for 0.5% to 5% of the total mass of the second conductive material.

In some embodiments, the diameter of the silver nanowire is 10 to 100 nm, and the length is 10 to 100 μm. In some embodiments, the diameter of the silver nanowire is 10 to 40 nm, and the length is 20 to 40 μm. Considering the usage, conductivity, transmittance and other parameters of the silver nanowires in the conductive film, the silver nanowires need to meet a certain length-diameter ratio, and the length-diameter ratio of the silver nanowires is preferably 100 to 10000. It should be noted that the length and diameter of the silver nanowires are all statistical values, which does not mean that each silver nanowire meets the above specifications, and there may be a size error within ±10% between different silver nanowires.

In some embodiments, the first ligand and the second ligand are respectively independently selected from one or more of a nanoparticle ligand, an organic small molecule ligand and a polymer ligand.

In some embodiments, the nanoparticle ligand is an inorganic nanoparticle ligand or an organic nanoparticle ligand, the inorganic nanoparticle ligand is selected from at least one of inorganic salts, metal oxide particles, metal particles and SiO₂ nanospheres, and the organic nanoparticle ligand is selected from at least one of micelle microspheres and polymer microspheres. Preferably, the size of the organic nanoparticle ligand is at nanometer scale.

The inorganic nanoparticle ligand is generally bound to the surface of the conductor by adsorption. The inorganic nanoparticle ligand can regulate the characteristics of the conductive materials such as transmittance, sheet resistance and weather resistance, and can make the conductive film have higher transmittance and lower sheet resistance, thus meeting more stringent application requirements. In some embodiments, the inorganic nanoparticle ligand is a non-insulating nanoparticle. Examples of the non-insulating nanoparticle may be one or more of SnO₂ nanoparticles, Al₂O₃ nanoparticles, gold nanoparticles and the like. However, when the inorganic nanoparticle ligand is made of metal oxide particles and/or metal particles, and the mass ratio of the metal oxide particles and/or metal particles in the surface ligands of the conductor is 100%, the conductor may precipitate in the ink due to insufficient buoyancy, so it is preferable that the mass ratio of such ligands to the total ligands is less than 100%. In some embodiments, the inorganic nanoparticle ligand includes an inorganic nanoparticle body and a modifier on the surface of the inorganic nanoparticle body, and the affinity of the inorganic nanoparticle ligand is mainly determined by the affinity of the modifier. The modifier can increase the dispersibility of the above inorganic nanoparticle ligand in the ink solvent. In some embodiments, the inorganic salt can be an affiliativeoxychalcogenide metal complex, such as a complex containing groups such as Sn₂S₆⁴⁻ and In₂Se₄²⁻, and specific examples are (N₂H₅)₄Sn₂S₆ and the like.

In some embodiments, the micelle microsphere may be a small molecule micelle or polymer micelle. The small molecule micelle mainly includes a micelle with a bulk structure formed by self-assembly of a small molecule surfactant when the concentration reaches the critical micelle concentration (CMC). The molecular structure of the surfactant is amphoteric: one end is a hydrophilic group, the other end is a hydrophobic group; the hydrophilic group can be carboxylic acid, sulfonic acid, sulfuric acid, the amino group, or the amine group and their salts, hydroxyl group, amide group, etc., and the hydrophobic group may be alkanes, cyclic hydrocarbons, aromatics, straight chain esters or a combination of the above. When the hydrophobic tail end of the surfactant molecule gathers in the micelle and the hydrophilic head end is exposed outside, the small molecular micelle is the hydrophilic ligand; when the hydrophilic tail end of the surfactant molecule gathers in the micelle and the hydrophobic head end is exposed outside, the small molecular micelle is the hydrophobic ligand. The polymer micelles are core-shell structures formed by the interaction between the hydrophilic and hydrophobic chains of amphiphilic polymer materials. The affinity of the shell layer of the core-shell structure determines the affinity of the polymer micelles. It is possible to control the specific hydrophilic and hydrophobic chains to be located in the outer layer of polymer micelles through the process to form polymer micelles with corresponding affinities. The hydrophilic chain of the polymer micelle can be obtained by polymerization of the following functional monomers, which can be selected from any one or more of acrylic monomers (such as methacrylic acid, acrylic acid, etc.), acrylic monomers (such as dimethylaminoethyl methacrylate, hydroxyethyl methacrylate, etc.), acrylamide monomers (such as N-isopropylacrylamide, acrylamide, etc.); the hydrophobic chain may be obtained by polymerization of the following functional monomers, which may be selected from aliphatic hydrocarbons containing double bonds, aromatic hydrocarbons containing double bonds, esters containing double bonds, and any combination of the above. The amphiphilic polymer forming the polymer micelle may be a random copolymer, and also may be a block copolymer, a graft copolymer, a branched copolymer, as long as there are hydrophobic and hydrophilic chains which are copolymerized at a certain proportion. In some embodiments, groups with fixing function, such as double bonds, can be introduced into the polymer micelles, and the shape of micelle microspheres can be slightly fixed by UV curing reaction. The shape of the micelle microspheres can be fixed in different degrees according to the different densities of the double bonds. Generally speaking, the high density of double bonds in polymer micelles is more conducive to maintaining the original shape of micelles.

It should be pointed out that the materials (chemical composition) of the ligands of micelle microsphere type may overlap with those of organic small molecule ligands and polymer ligands in some extent, but their morphology and capping methods on the surface of the conductor are different, the micelle microspheres are mainly adsorbed on the surface of the conductor in bulk structure (such as spherical and ellipsoidal), while organic small molecule ligands are bonded with the conductor by single molecule, while polymer ligands are coated on the surface of the conductor in the form of molecular chain winding.

In some embodiments, the polymer microspheres may be polystyrene (PS) microspheres, polymethyl methacrylate (PMMA) microspheres, organosilicone microspheres, or a combination of the above, etc. The polymer microspheres are adsorbed on the surface of the conductor in bulk structures (such as spheres and ellipsoids). Preferably, the diameter of the polymer microspheres does not exceed 113 of the diameter of the corresponding conductor. The polymer microspheres are not conductive intrinsically, which can play a certain role in space barrier between conductors, thus avoiding unnecessary winding between conductors and facilitating the uniform distribution of conductive materials when forming films through coating. In addition, when the conductive materials are combined with carrier transport layer materials or electrode materials in the device (such as conductive material/ZnO nanocrystal composite, conductive material/ITO electrode composite, etc.), as the refractive index between different materials is different, and these polymer microspheres can also have a certain degree of light extraction effect. However, when the ratio of the ligand of the polymer microsphere type to the ligand on the surface of the conductor is 100%, the conductor may precipitate in the ink due to insufficient buoyancy. The polymer microspheres are preferably used with at least one of organic small molecule ligands, polymer ligands, and micelle microspheres.

In some embodiments, the molecular weight of the organic small molecule ligand is not more than 500, the molecular weight of the polymer ligand is 5,000 to 500,000, and preferably, the molecular weight of the polymer ligand is 20,000 to 200,000. If the molecular weight of the polymer ligand is too large, its solubility may become poor.

In some embodiments, the structural formula of the organic small molecule ligand is X-Y, X is used to coordinate with the surface of the first conductor or the second conductor, the structure of Y includes a hydrophilic group or a hydrophobic group, the hydrophilic group is selected from at least one of a hydroxyl group, a carboxyl group, an aldehyde group, an amino group, an amine group, a sulfonic group and a sulfinyl group, and a hydrophobic group is selected from at least one of a saturated aliphatic group, an unsaturated aliphatic group, halogen, an aromatic hydrocarbon group, an ester group and a nitro group; preferably, X is selected from sulfhydryl group, amino group, carboxyl group, sulfonic group or phosphate group. The structure of Y also includes a linking group connecting X with a hydrophilic/hydrophobic group. And in some embodiments, the number of carbon atoms in the above linking group is 2 to 18. The X mentioned above is used for coordination with the conductive body, and there is no requirement on the affinity of X. The structure of Y may include at least one hydrophilic group and/or at least one hydrophobic group, as long as the overall affinity of organic small molecule meets the requirements of this disclosure. Examples of the hydrophilic organic small molecule ligand can be mercaptoacetic acid, thioglycolamine, etc., examples of hydrophobic organic small molecule ligand can be alkyl phosphine (such as trioctylphosphine, trioctylphosphine oxide, etc.), long chain alkyl amine (such as hexamine, octylamine, etc.), alkyl mercaptan (such as dodecylthiol, 2-ethylhexyl mercaptan, 1-cetylmercaptan, etc.)

In some embodiments, the polymer ligands are selected from one or more of PVP (polyvinylpyrrolidone), PEO (polyethylene oxide), PEG (polyethylene glycol), PIB (polyisobutene), PVK (polyvinyl carbazole), PVB (polyvinyl butyral), PSS (polystyrene sulfonic acid or sodium polystyrene sulfonate), cycloolefin copolymer (olefin polymer) and fluorine-containing resin, but not limited thereto. PVP, PEO, PEG, PVB and PSS belong to hydrophilic ligands, and PIB, PVK, cycloolefin copolymer and fluorine-containing resin belong to hydrophobic ligands.

The disclosure provides an exemplary method for distinguishing the affinity of an organic small molecule ligand or a polymer ligand: the hydrophilic ligand and hydrophobic ligand are distinguished according to the HLB value of the ligand molecule, when the HLB value is less than 10, it is generally hydrophobic (or lipophilic), when the HLB value is more than 10, it is generally hydrophilic, and the higher the HLB value, the stronger the hydrophilicity. HLB value being equal to 10 defines the dividing line, and the affinities of ligands located on both sides of the dividing line are considered to be exclusive.

Specifically, when at least one hydrophilic group and/or at least one hydrophobic group is included in the same ligand molecule, its HLB value can be calculated according to the following formula, HLB=20*(M_{hydrophilic}/Mₜₒₜₐₗ), for the polymer ligand, M_{hydrophilic} refers to the sum of the molecular weights of the hydrophilic groups in the ligand molecule, and Mₜₒₜₐₗ refers to the total molecular weight of the ligand itself. For the organic small molecule ligand, M_{hydrophilic} refers to the sum of the molecular weights of the remaining hydrophilic groups in the ligand molecule except for a bonding group; Mₜₒₜₐₗ refers to the total molecular weight of the remaining groups in the ligand molecule, excluding the bonding group; the bonding group refers to a group attached to the surface of the first conductor or the second conductor in the ligand molecule, i.e., the group X. Since the factors influencing the affinity of the compound are not single, the above formula is only an empirical formula, it is not excluded that the actual affinity of some compounds does not accord with the judgment results of the above calculation formula, and therefore, the above method for distinguishing the affinity of the ligand cannot be used as an improper limitation to the protection scope of the technical solution of the present disclosure.

In some embodiments, one or both of the first ligand and the second ligand is a mixed ligand, the HLB value of each ligand is tested or calculated separately, and then multiplied by the mass ratio of each ligand to get each product, and the HLB value of the mixed ligand is obtained by adding each product. For example, the first ligand includes three ligands a, b and c, the ligand a accounts for x % of the total mass of the first ligand, the ligand b accounts for y % of the total mass of the first ligand, the ligand c accounts for z % of the total mass of the first ligand, the second ligand includes two ligands d and e, the ligand d accounts for m % of the total mass of the second ligand, and the ligand e accounts for n % of the total mass of the second ligand, so that for the first ligand, HLB 1=HLBₐ*x %+HLB_{b}*y %+HLB_{c}*z %, HLB 2=HLB_{d}*m %+HLBₑ*n %, as long as one of the final HLB 1 and the HLB 2 being greater than 10, and the other being less than 10 is ensured. It is to be noted that since the inorganic nanoparticle ligand of the metal oxide particle or metal particle type and the organic nanoparticle ligand of the polymer microsphere type has little influence on the affinity of the mixed ligand, the ligands of the above-mentioned type can be omitted in the calculation process of the HLB value of the mixed ligand, and the mass ratio of each ligand to the total mass of the above first ligand (or the second ligand) in the calculation of the HLB should not consider the mass of the above types of ligands.

In some embodiments, a sheet resistance of the conductive film is ≤500Ω/□. In some embodiments, the sheet resistance of the conductive film is ≤100Ω/□. A lower sheet resistance may enable good conductivity. Sheet resistance testing has a high requirement on the environment. It needs to be measured in a relatively constant environment to reduce temperature and humidity deviations and other data deviations caused by uncertain operations. The standard ambient temperature and humidity of sheet resistance testing in the disclosure are: 22±2° C., 55%±5%.

In some embodiments, a visible light transmittance of the conductive film is ≥70%, that is, the transmittance of the conductive film to light in the visible range is 70%; and in some embodiments, the visible light transmittance of the conductive film is 85%. The transmittance of the conductive film is determined by the distribution density and distribution uniformity of the conductive material in the conductive film, and therefore, a high light transmittance of the conductive film indicates a good distribution density and distribution uniformity of the conductive material in the conductive film.

In some embodiments, the thickness of the conductive film is 20 to 500 nm. The thickness of the conductive film refers to the thickness obtained by testing the cross section of the film with a scanning electron microscope (SEM). The conductive film can be a network film formed by overlapping conductive materials, for example, the first conductor and the second conductor in the conductive film can overlap, the first conductor and the first conductor can overlap, and the second conductor and the second conductor can overlap.

According to another aspect of the disclosure, anink formulation is provided, which includes a first ink and a second ink, the first ink includes a first conductive material and a first solvent, the second ink includes a second conductive material and a second solvent, the first conductive material includes a first conductor and a first ligand coating the surface of the first conductor, the second conductive material includes a second conductor and a second ligand coating the surface of the second conductor, and the first ligand and the second ligand have mutually exclusive affinities to water.

The first ink and the second ink are not used at the same time or mixed together. The surfaces of the first conductive material and the second conductive material have ligands with mutually exclusive affinities to water, then when the conductive film is prepared by the first ink and the second ink, the area with a larger distribution density of the first conductive material can produce more repulsion to the second conductive material, which is beneficial for the second conductive material to deposit on the area where the distribution density of the original first conductive material is small or uncovered part of the substrate, so as to form conductive film with uniform distribution of the conductive material. The conductive film prepared by the above materials has the advantages of good conductivity and high light transmittance. The light transmittance of the device with the conductive film is improved.

In some embodiments, the solid content of the conductive material of the first ink and the second ink is independently 0.01 wt % to 10 wt %. The above solid content is conducive to ensure that conductive materials can contact each other to form a conductive network structure, and the local accumulation concentration will not be too high to reduce the light transmittance of the conductive film during single coating.

In order to take into account the conductivity of conductive film while improving the distribution uniformity of conductive materials, in some embodiments, the mass of the first ligand accounts for 0.1% to 10% of the total mass of the first conductive material; and the mass of the second ligand accounts for 0.1% to 10% of the total mass of the second conductive material. In some embodiments, the mass of the first ligand accounts for 0.5% to 5% of the total mass of the first conductive material; and the mass of the second ligand accounts for 0.5% to 5% of the total mass of the second conductive material.

In some embodiments, the weight ratio of the first conductive material to the second conductive material is 1:10 to 10:1. In some embodiments, the weight ratio of the first conductive material to the second conductive material is 1:3 to 3:1. The concentrations of the first conductive material and the second conductive material are appropriately close, which is beneficial to the distribution uniformity of the conductive materials.

In some embodiments, the surface tension of the first ink is 30 to 70 mN/m, and the surface tension of the second ink is 20 to 40 mN/m. The film formation of the first ink with the surface tension in the above range can ensure that the second ink disposed on the pre-conductive layer has good lubricity, which is conducive to better play the affinity and repelling effect of the first ligand and the second ligand to realize the regional selective deposition of the second conductive material. In a specific implementation mode, the first ligand is a hydrophilic ligand, the second is a hydrophobic ligand, the first solvent is a polar solvent, and the second is a non-polar solvent. One or both of the first solvent and the second solvent may be mixed solvents. Examples of the polar first solvent may be one or more of water, mono alcohol, polyol, alcohol ether, DMF and DMSO, etc., and examples of the non-polar second solvent may be one or more of aromatics, alkanes, esters and carbon tetrachloride, etc. In another specific implementation mode, the first ligand is a hydrophobic ligand, the second ligand is a hydrophilic ligand, the first solvent is a non-polar solvent, the second solvent is a polar solvent, and the surface tension of the first ink is greater than that of the second ink. One or both of the first solvent and the second solvent may be mixed solvents. Examples of the non-polar first solvent may be one or more of aromatics and esters, and examples of the polar second solvent may be one or more of mono alcohol and alcohol ether. In the above embodiment, the polarities of the first solvent and the second solvent are opposite, which is conducive to the distribution and distribution uniformity of the first conductor and the second conductor.

In some embodiments, the first conductor and the second conductor are metal nanowires. In a preferred implementation mode, the first conductor and the second conductor are silver nanowires.

In some embodiments, the first ligand and the second ligand are respectively independently selected from one or more of a nanoparticle ligand, an organic small molecule ligand and a polymer ligand.

In some embodiments, the nanoparticle ligand is an inorganic nanoparticle ligand or an organic nanoparticle ligand, the inorganic nanoparticle ligand is selected from at least one of inorganic salts, metal oxide particles, metal particles and SiO₂ nanospheres, and the organic nanoparticle ligand is selected from at least one of micelle microspheres and polymer microspheres. Preferably, the size of the organic nanoparticle ligand is at nanometer scale. The specific selection of inorganic nanoparticle ligand and organic nanoparticle ligand has been described in detail above and will not be repeated here.

In some embodiments, the structural formula of the organic small molecule ligand is X-Y, X is used to coordinate with the surface of the first conductor or the second conductor, the structure of Y includes a hydrophilic group or a hydrophobic group, the hydrophilic group is selected from at least one of a hydroxyl group, a carboxyl group, an aldehyde group, an amino group, an amine group, a sulfonic group and a sulfinyl group, and a hydrophobic group is selected from at least one of a saturated aliphatic group, an unsaturated aliphatic group, halogen, an aromatic hydrocarbon group, an ester group and a nitro group; preferably, X is selected from sulfhydryl group, amino group, carboxyl group, sulfonic group or phosphate group. The structure of Y also includes a linking group connecting X with a hydrophilic/hydrophobic group, and in some embodiments, the number of carbon atoms in the above linking group is 2 to 18. The X mentioned above is used for coordination with the conductive body, and there is no requirement on the affinity of X. The structure of Y may include at least one hydrophilic group and/or at least one hydrophobic group, as long as the overall affinity of small organic molecule meets the requirements of this disclosure.

In some embodiments, the polymer ligands are selected from one or more of polyvinylpyrrolidone (PVP), polyethylene oxide (PEO), polyethylene glycol (PEG), polyisobutene (PIB), polyvinyl carbazole (PVK), polyvinyl butyral (PVB), polystyrene sulfonic acid or sodium polystyrene sulfonate (PSS), cycloolefin copolymer (olefin polymer) and fluorine-containing resin, but not limited thereto.

In some embodiments, the molecular weight of the organic small molecule ligand is not more than 500, the molecular weight of the polymer ligand is 5,000 to 500,000, and preferably, the molecular weight of the polymer ligand is 20,000 to 200,000. If the molecular weight of the polymer ligand is too large, its solubility may become poor.

In some embodiments, the first ligand and/or the second ligand are/is a mixed ligand, the HLB value of each ligand is tested or calculated separately, and then multiplied by the mass ratio of each ligand, and the HLB value of the mixed ligand is obtained by adding each product. HLB value being equal to 10 defines the dividing line, and the affinities of ligands located on both sides of the dividing line are considered to be exclusive.

In some embodiments, the first ink and the second ink further include an additive, and the additive includes at least one of a viscosity regulator and a surface tension regulator. In the above embodiment, the mass fraction of the additive in the first ink and the second ink is preferably 0.01 wt % to 5 wt % independently. The viscosity regulator can have the function of adjusting ink viscosity, such as PEO, PVA, FIB, PMMA, etc.; the surface tension regulator is configured to further regulate the surface tension of ink, such as Triton-100, Tween-20, fluorinated polyacrylates, silane coupling agents, etc.

According to still another aspect of the disclosure, a preparation method of a conductive film is provided, which includes the following steps: S1, a substrate is provided; S2, a first ink is disposed on the substrate, and drying treatment is carried out to form a pre-conductive layer; S3, a second ink is disposed on the pre-conductive layer, and drying treatment is carried out; the first ink includes a first conductive material and a first solvent, the second ink includes a second conductive material and a second solvent, the first conductive material includes a first conductor and a first ligand coating the surface of the first conductor, the second conductive material includes a second conductor and a second ligand coating the surface of the second conductor, and the first ligand and the second ligand have mutually exclusive affinities to water.

With the application of the technical solution of the disclosure, first, the first ink containing the first conductive material is disposed on the substrate to form the pre-conductive layer, then the second ink containing the second conductive material is disposed on pre-conductive layer, the surfaces of the first conductive material and the second conductive material have ligands with mutually exclusive affinities to water, then the area with a larger distribution density of the first conductive material in the pre-conductive layer can produce more repulsion to the second conductive material in the second ink, which is beneficial for the second conductive material to deposit on the area where the distribution density of the original first conductive material in the pre-conductive layer is small or uncovered part of the substrate, so as to reduce the excessive stacking or aggregation of the conductive material and form conductive film with uniform distribution of the conductive material. The conductive film prepared by the above preparation method has the advantages of good conductivity and high light transmittance. The light transmittance of the device with the conductive film is improved.

The ink can be conductive or not conductive, mainly depending on the concentration of the conductive materials in the ink, when the concentration of the conductive materials in the ink is small, the conductive materials in the ink may not contact each other, then the ink is not conductive; when the concentration of the conductive materials in the ink is large, the conductive materials in the ink are in contact with each other, and the ink is conductive.

In some embodiments, the first ink may be disposed in S2 by means of spin coating, spray coating, slit coating or inkjet printing, etc., and the second ink may be disposed in S3 by means of spin coating, spray coating, slit coating or inkjet printing, etc.

In some embodiments, the drying method in S2 can be natural drying, hot plate baking or radiant baking. In a preferred implementation mode, incomplete drying can be adopted in S2, as long as the first conductive material in the pre-conductive layer loses the ability to move. That is, the position between the first conductive materials is fixed and no longer affected by the solvent.

In some embodiments, the drying method in S3 can be natural drying, hot plate baking or radiant baking.

In some embodiments, S2 and S3 are repeated at least once after S3. A thicker conductive film is realized.

In some embodiments, the first ligand and the second ligand are respectively independently selected from one or more of a nanoparticle ligand, an organic small molecule ligand and a polymer ligand.

In some embodiments, the nanoparticle ligand is an inorganic nanoparticle ligand or an organic nanoparticle ligand, the inorganic nanoparticle ligand is selected from at least one of inorganic salts, metal oxide particles, metal particles and SiO₂ nanospheres, and the organic nanoparticle ligand is selected from at least one of micelle microspheres and polymer microspheres. Preferably, the size of the organic nanoparticle ligand is at nanometer scale. The specific selection of inorganic nanoparticle ligand and organic nanoparticle ligand has been described in detail above and will not be repeated here.

In some embodiments, the structural formula of the organic small molecule ligand is X-Y, X is used to coordinate with the surface of the first conductor or the second conductor, the structure of Y includes a hydrophilic group or a hydrophobic group, the hydrophilic group is selected from at least one of a hydroxyl group, a carboxyl group, an aldehyde group, an amino group, an amine group, a sulfonic group and a sulfinyl group, and a hydrophobic group is selected from at least one of a saturated aliphatic group, an unsaturated aliphatic group, halogen, an aromatic hydrocarbon group, an ester group and a nitro group; preferably, X is selected from sulfhydryl group, amino group, carboxyl group, sulfonic group or phosphate group. The structure of Y also includes a linking group connecting X with a hydrophilic/hydrophobic group, and in some embodiments, the number of carbon atoms in the above linking group is 2 to 18. The X mentioned above is used for coordination with the conductive body, and there is no requirement on the affinity of X. The structure of Y may include at least one hydrophilic group and/or at least one hydrophobic group, as long as the overall affinity of small organic molecule meets the requirements of this disclosure.

In some embodiments, the polymer ligands are selected from one or more of polyvinylpyrrolidone (PVP), polyethylene oxide (PEO), polyethylene glycol (PEG), polyisobutene (PIB), polyvinyl carbazole (PVK), polyvinyl butyral (PVB), polystyrene sulfonic acid or sodium polystyrene sulfonate (PSS), cycloolefin copolymer (olefin polymer) and fluorine-containing resin, but not limited thereto.

In some embodiments, the molecular weight of the organic small molecule ligand is not more than 500, the molecular weight of the polymer ligand is 5,000 to 500,000, and preferably, the molecular weight of the polymer ligand is 20,000 to 200,000. If the molecular weight of the polymer ligand is too large, its solubility may become poor.

In some embodiments, the first ligand and/or the second ligand are/is a mixed ligand, the HLB value of each ligand is tested or calculated separately, and then multiplied by the mass ratio of each ligand to obtain each product, and the HLB value of the mixed ligand is obtained by adding each product. HLB value being equal to 10 defines the dividing line, and the affinities of ligands located on both sides of the dividing line are considered to be exclusive.

In some embodiments, the solid content of the conductive material of the first ink and the second ink is independently 0.01 wt % to 10 wt %. The above solid content is conducive to ensure that conductive materials can contact each other to form a conductive network structure, and the local accumulation concentration will not be too high to reduce the light transmittance of the conductive film during single coating.

In order to take into account the conductivity of conductive film while improving the distribution uniformity of conductive materials, in some embodiments, the mass of the first ligand accounts for 0.1% to 10% of the total mass of the first conductive material; and the mass of the second ligand accounts for 0.1% to 10% of the total mass of the second conductive material. In some embodiments, the mass of the first ligand accounts for 0.5% to 5% of the total mass of the first conductive material; and the mass of the second ligand accounts for 0.5% to 5% of the total mass of the second conductive material.

In some embodiments, the weight ratio of the first conductive material to the second conductive material is 1:10 to 10:1. In some embodiments, the weight ratio of the first conductive material to the second conductive material is 1:3 to 3:1. The concentrations of the first conductive material and the second conductive material are appropriately close, which is beneficial to the distribution uniformity of the conductive materials.

In some embodiments, the surface tension of the first ink is 30 to 70 mN/m, and the surface tension of the second ink is 20 to 40 mN/m. The film formation of the first ink with the surface tension in the above range can ensure that the second ink disposed on the pre-conductive layer has good lubricity, which is conducive to better play the affinity and repelling effect of the first ligand and the second ligand to realize the regional selective deposition of the second conductive material. In a specific implementation mode, the first ligand is a hydrophilic ligand, the second is a hydrophobic ligand, the first solvent is a polar solvent, and the second is a non-polar solvent. The first solvent and/or the second solvent may be a mixed solvent. Examples of the polar first solvent may be one or more of water, mono alcohol, polyol, alcohol ether, DMF and DMSO, etc., and examples of the non-polar second solvent may be one or more of aromatics, alkanes, esters and carbon tetrachloride, etc. In another specific implementation mode, the first ligand is a hydrophobic ligand, the second ligand is a hydrophilic ligand, the first solvent is a non-polar solvent, the second solvent is a polar solvent, and the surface tension of the first ink is greater than that of the second ink. The first solvent and/or the second solvent may be a mixed solvent. Examples of the non-polar first solvent may be one or more of aromatics and esters, and examples of the polar second solvent may be one or more of mono alcohol and alcohol ether.

In some embodiments, the first ink and the second ink further include an additive, and the additive includes at least one of a viscosity regulator and a surface tension regulator. In the above embodiment, the mass fraction of the additive in the first ink and the second ink is preferably 0.01 wt % to 5 wt % independently. The viscosity regulator can have the function of adjusting ink viscosity, such as PEO, PVA, PIB, PMMA, etc.; the surface tension regulator is configured to further regulate the surface tension of ink, such as Triton-100, Tween-20, fluorinated polyacrylates, silane coupling agents, etc.

In some embodiments, the first conductor and the second conductor are metal nanowires. In a preferred implementation mode, the first conductor and the second conductor are silver nanowires.

In some embodiments, a sheet resistance of the conductive film is ≤500Ω/□. In some embodiments, the sheet resistance of the conductive film is ≤100 Ω/□.

In some embodiments, the transmittance of the conductive film in the visible range is ≥70%; and in some embodiments, the transmittance of the conductive film in the visible range is ≥85%. The transmittance of the conductive film is determined by the distribution density and distribution uniformity of the conductive material in the conductive film, and therefore, a high transmittance of the conductive film indicates a good distribution density and distribution uniformity of the conductive material in the conductive film.

In some embodiments, the thickness of the conductive film is 20 to 500 nm. The conductive film can be a network film formed by overlapping conductive materials, and the thickness of the conductive film refers to the thickness obtained by testing the cross section of the film with an SEM.

According to yet another aspect of the disclosure, a device containing the conductive film described above or the conductive film prepared by the above preparation method is provided. The above device may be a light emitting device (an electroluminescent Light Emitting Diode (LED), an electroluminescent LED with an optical conversion function), a touch control device, a sensing device, a solar cell, etc. Because the conductive film has good conductivity and high light transmittance, the product quality of the device is improved.

In some embodiments, the device is an Organic Light-Emitting Diode (OLED) device, a Quantum dot Light Emitting Diode (QLED) device, a mini-LED device or a micro-LED device.

In some embodiments, the device includes a first electrode, a functional layer and a second electrode which are sequentially stacked, and the first electrode and/or the second electrode include/includes the conductive film.

In some embodiments, one of the first and second electrodes does not include the conductive film, and the electrode excluding the conductive film may be a transparent electrode (e.g. ITO, AZO, etc.) or a reflective electrode (e.g. Ag, Al, or its alloys, etc.). The above functional layer can include more of an electron injection layer, an electron transport layer, an electron barrier layer, a luminescent layer, a hole barrier layer, a hole injection layer, and a hole transport layer, and the material of the luminescent layer can be selected from OLED small molecules, polymer luminescent materials or quantum dot materials. The device may also include a substrate, such as a rigid substrate such as glass or silicon wafer, or a flexible substrate such as PI, PEN, PET.

In some embodiments, the first electrode and/or the second electrode may contain only the conductive film, excluding other conductive materials.

In some embodiments, the functional layer of the device has a first functional layer close to the first electrode and a second functional layer close to the second electrode, and the device has at least one of characteristic A and characteristic B: A, the conductive film of the first electrode and the first functional layer are embedded with each other; B, the conductive film of the second electrode and the second functional layer are embedded with each other. “Embedded with each other” means that a part of the conductive material of the conductive film of the first electrode enters the functional layer of the first part, and a part of the material of the first functional layer enters the conductive film of the first electrode.

The device in the above embodiment can be prepared by the following method: a substrate is provided, a conductive film is fabricated on the substrate, and a material of the functional layer is disposed on the conductive film, since the conductive film has a network structure, at least some of the material of the functional layer will fill the holes of the conductive film, so that the conductive film and the first part of the functional layer are embedded with each other; or, a substrate is provided, a functional layer is disposed on the substrate, the conductive film is disposed on the surface when only the last part of the functional layer is left to be fabricated, then the last part of the functional layer material is applied on the conductive film, at least part of this part of the functional layer material will fill in the holes of the conductive film, so that the conductive film and the second part of the functional layer can be embedded with each other.

In some embodiments, the conductive film of the first electrode and/or the second electrode is disposed adjacent to the functional layer. It can be prepared by the following method: first, a conductive film is prepared on a hard substrate (such as glass), and then polyimide (PI) or other coatable material is disposed on the conductive film, after curing, the conductive film and the PI layer are stripped from the hard substrate together, at this time, the peeling surface of the conductive film will be very flat, and the conductive material is exposed on the surface, and the conductive film can be disposed adjacent to the functional layer by disposing the functional layer on the surface.

In some embodiments, the first electrode of the device is composed of a conductive film and a base electrode material; and in some embodiments, the second electrode is composed of a conductive film and a top electrode material. The first electrode can be prepared by the following method: first, the conductive film is prepared on the substrate, then the bottom electrode material (such as ITO) is sputtered on the conductive film, and the conductive film is embedded in the bottom electrode material; or, the conductive film is fabricated on the substrate first, and then the bottom electrode material in solution state is coated on the conductive film, and the composite film is formed after high temperature annealing. The alternative preparation method of the second electrode mentioned above is the same as that of the first electrode, only the bottom electrode material needs to be replaced by the top electrode material.

In some embodiments, the device includes a carrier transport layer, part of the material of the carrier transport layer is embedded in the conductive film, and part of the surface of the conductive film is covered by the carrier transport layer. The carrier transport layer includes at least one of a hole injection layer, an electron injection layer and an electron transport layer.

The beneficial effects of the disclosure will be further described with reference to specific embodiments and comparative examples.

### Examples 1-5

1. Synthesis of Silver Nanowires:

With ethylene glycol as a solvent, under the assistance of the stabilizer polyethylpyrrolidone (PVP), by controlling the reaction time, temperature, loading rate, PVP molecular weight and concentration, silver nitrate with a certain concentration of halogen salts (such as sodium bromide, sodium chloride, copper chloride, etc) was use to obtain silver nanowires of different diameters and lengths, and the growth morphology of silver nanowires was adjusted. The synthesis of silver nanowires belongs to prior art and those skilled in the art could choose any suitable method randomly.

In this example, a silver nanowire with a diameter of 20 nm and a length of 30 μm was used as the research object to illustrate the beneficial effect of the disclosure.

2. Ligand Exchange of Silver Nanowire:

By introducing a certain amount of target ligand directly for replacement, or by introducing ligand exchange additives such as nitrite tetrafluoroborate (NOBF₄) to improve the replacement ability of the target ligand, the PVP ligand on the surface of silver nanowires synthesized in S1 was replaced as the target ligand. The ligand exchange method belongs to prior art and those skilled in the art could choose any suitable method randomly.

The mass ratio of ligand in silver nanowires was measured by a thermogravimetric analyzer, and the surface tension of ink was measured by a surface tensimeter.

The parameters of the silver nanowires and inks were shown in Table:

TABLE 1

| | | | | | | Ingredients | |
|---|---|---|---|---|---|---|---|
| | | | | Mass | Solvent | of additive, | |
| | | HLB | Mass | ratio of | composition of | and mass | Surface |
| | | value | ratio | silver | ink, and mass | ratio of | tension |
| | | of | of | nanowire | ratio of solvent | additive in | of ink |
| Example | Ligand | ligand | ligand | in ink | in ink | ink | mN/m |
| 1 | Octylame | ~0 | 1.47% | 2% | Xylene 98 wt % | None | 28 |
| 2 | Butanolamine | ~5.4 | 3.76% | 1.5% | Phenoxetol | None | 37 |
| | | | | | 98.5 wt % | | |
| 3 | Mercaptoacetic | ~15.2 | 4.86% | 1% | Water 60 wt %; | TritonX-100 | 33 |
| | acid | | | | Ethylene glycol | 0.1 wt % | |
| | | | | | 38.9 wt % | | |
| 4 | Polyethylene | ~20 | 0.59% | 0.5% | Water 60 wt %; | None | 46 |
| | oxide | | | | Ethylene glycol | | |
| | PEO | | | | 39.5 wt % | | |
| 5 | SnO₂ | ~15.1 | 8%, | 3% | Propylene | PVP | 31 |
| | nanoparticles, | | 1.52% | | glycol | molecular | |
| | PVP | | | | monomethyl | weight | |
| | | | | | ether 50 wt %; | 550000 | |
| | | | | | water 46.5 wt % | 0.5 wt % | |

In Table 1, “mass ratio of ligand” was obtained by dividing the mass of ligand on the surface of silver nanowire by the mass of silver nanowire itself; for “mass ratio of silver nanowire in ink”, the mass of silver nanowire included the mass of ligand on the surface of silver nanowire; for “mass ratio of solvent in ink” and “mass ratio of additive in ink” were obtained that the mass of solvent/additive to the mass of ink. In Example 1, the amine group of the ligand octylamine was linked to the surface of the silver nanowires, and the carbon chain was dissociated outside; in Example 2, the amine group of the ligand but anolamine was linked to the surface of the silver nanowires; in Example 3, the sulfhydryl group of ligand mercaptoacetic acid was bonded to the surface of the silver nanowires. In Example 5, the average particle size of SnO₂ nanoparticles was about 0.79 nm. The symbol “˜” represented“about”.

It should be pointed out that the degree to which the PVP ligand on the surface of silver nanowires was replaced into the target ligand mainly depended on the coordination ability of the target ligand itself. According to the TG analysis, only a small amount of PVP ligand remained on the surface of the silver nanowires obtained in Examples 1 to 4, and the replacement of the target ligand was relatively complete. Therefore, the affinity of the silver nanowires after ligand exchange could be evaluated according to the HLB value of the target ligand. The surface of the silver nanowires obtained in Example 5 was a mixed ligands of SnO₂ nanoparticles and PVP, SnO₂ nanoparticles were mainly configured to reduce the square resistance of the conductive film, but had little effect on the affinity of silver nanowires, therefore, the affinity of silver nanowires in Example 5 could be evaluated only according to the HLB value of the PVP ligand.

### Examples 6 to 8

Conductive film and its fabrication: inks in the above Examples 1 to 5 were selected for the combination of the first ink and the second ink (see Table 2), and KTQ-III film applicator was used for the fabrication of conductive film. The coating process was as follows.

White glass substrate was subjected to ultrasonic washing with acetone, isopropyl alcohol, and ultra-pure water, and blown by nitrogen. A to-be-coated surface was treated by plasma, the white glass substrate was placed on a marble base in a thousand-grade clean room, the first ink was removed to the substrate with a pipette gun, and coating process was carried out with a KTQ-III type film applier at a certain gap and rate. After air drying, the second ink was removed with a pipette gun and the above coating process was repeated. After drying, the substrate coated with conductive material was transferred into a glove box under nitrogen atmosphere, and baking was carried out at 80° C. with a hot plate for 30 minutes to obtain the conductive film, with specific parameters shown in Table 2. The thickness of the conductive film was obtained by scanning the cross section with an SEM, the transmittance was measured by a UV-visible spectrophotometer, and the square resistance was obtained by a four-probe square resistance tester.

### Example 9

The difference between this example and Example 6 was that the coating operation of the first ink and the second ink was repeated once each on the substrate coated with the conductive material.

### Comparative Examples 1 to 3

The difference between Comparative Examples and Examples 6, 7 and 8 was that the surface of silver nanowires was PVP ligand without ligand exchange, and the ligand mass ratio of the first ink and the second ink in Comparative Example 1 and the mass ratio of silver nanowires in inks were consistent with the conditions of the two inks used in Example 6, respectively, the above parameters in Comparative Example 2 were consistent with those in Example 7, and the above parameters in Comparative Example 3 were consistent with those in Example 8.

TABLE 2

| | | | Sheet | Transmittance |
|---|---|---|---|---|
| | | | resistance of | of |
| | | | conductive film | conductive film |
| Number | First ink | Second ink | (Ω/□) | at 550 nm |
| Example 6 | Example 4 | Example 2 | 450 | 98.5% |
| Comparative | — | — | 758 | 91.3% |
| Example 1 | | | | |
| Example 7 | Example 3 | Example 1 | 81 | 97.3% |
| Comparative | — | — | 139 | 87.6% |
| Example 2 | | | | |
| Example 8 | Example 2 | Example 5 | 8 | 84.7% |
| Comparative | — | — | 22 | 64.0% |
| Example 3 | | | | |
| Example 9 | Example 4 | Example 2 | 231 | 98% |

The electroluminescence device was manufactured by combining the fabrication process of the conductive film above, the structure of the device was: white glass substrate/bottom electrode/hole injection layer PEDOT: PSS/hole transport layer (thickness 40 nm) TFB/red quantum dot layer (thickness 25 nm)/zinc oxide electron transport layer (thickness 50 nm)/top electrode.

PEDOT: PSS hole injection layer: a 0.22 μm N66 filter head was used for filtration, and the parameters were set at 3500 rpm and 45 s, PEDOT: PSS was spin coated on the white glass substrate/bottom electrode, then annealing was carried out for 20 min on a hot table at 150° C. in air, after annealing, O₂ plasma treatment was carried out for 4 min, and then the work piece was rapidly transferred into a glove box.

TFB hole transport layer: 8 mg/mL TFB ethylbenzene solution was filtered by a 0.22 μm PTFE filter head, spin coating was carried out at 3000 rpm to form a film, annealing was carried out for 20 min on a hot table at 150° C. to complete the preparation of the hole transport layer.

Red quantum dot layer: the parameters were set at 2000 rpm and 45 s, a quantum dot solution was spin coated on the hole transport layer, and the structure of the red quantum dot was CdSe/CdZnSe/ZnSeS. The optical density (OD) of the quantum dot solution was 30 to 40 at 400 nm, and it was dissolved in n-octane, the layer was without annealing treatment.

Zinc oxide electron transport layer: the parameters were set at 3000 rpm and 30 s, and zinc oxide nanocrystal solution was spin coated on the quantum dot layer.

### Example 10

The electroluminescence device was a top-emitting device, the bottom electrode was a reflective electrode of 120 nm thickness of Ag and 15 nm thickness of ITO, the top electrode adopted the conductive film in Example 6, the thickness of which was about 85 nm.

### Example 11

The electroluminescent device was the base emitting device, the bottom electrode adopted the conductive film in Example 7, the thickness was about 105 nm, the top electrode was the Ag electrode, and the thickness is 100 nm.

### Example 12

The electroluminescence device was a double-side-emitting device, the bottom electrode was a standard ITO, the thickness was 150 nm, the top electrode adopted the conductive film in Example 8, the thickness of which was about 350 nm.

### Comparative Example 4

The difference between this comparative example and Example 10 was that the conductive film obtained from Comparative Example 1 was used as the top electrode.

### Comparative Example 5

The difference between this comparative example and Example 11 is that the conductive film obtained from Comparative Example 2 was used as the bottom electrode.

### Comparative Example 6

The difference between this comparative example and Example 12 was that the conductive film obtained from Comparative Example 3 was used as the top electrode.

The luminescence uniformity of the devices obtained in Examples 10 to 12 and Comparative Examples 4 to 6 were characterized by 500 times magnification of the microscope, the external quantum efficiency (EQE) of the devices was tested by PR670, the external quantum efficiency in Example 12 and Comparative Example 6 was the sum of the external quantum efficiency of both sides. The testing result was recorded in Table 3.

TABLE 3

| | Example | Example | Example | Comparative | Comparative | Comparative |
|---|---|---|---|---|---|---|
| Number | 10 | 11 | 12 | Example 4 | Example 5 | Example 6 |
| EQE (%) | 17.5 | 17.7 | 16.6 | 14.3 | 13.7 | 11.1 |

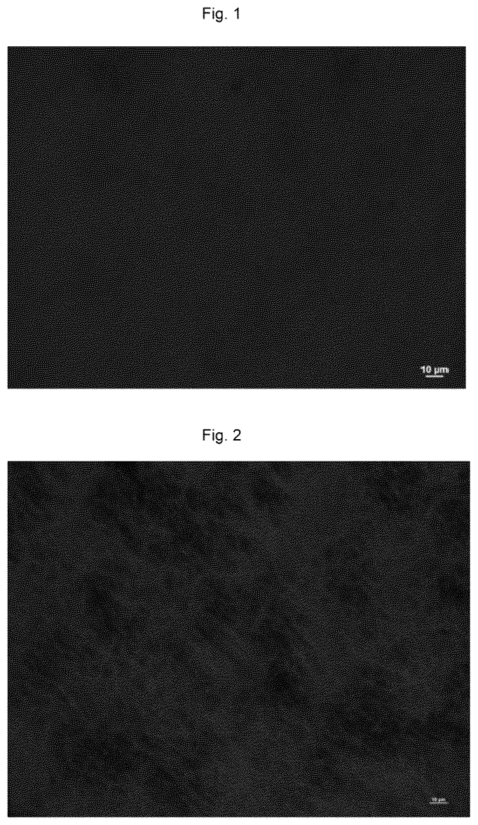

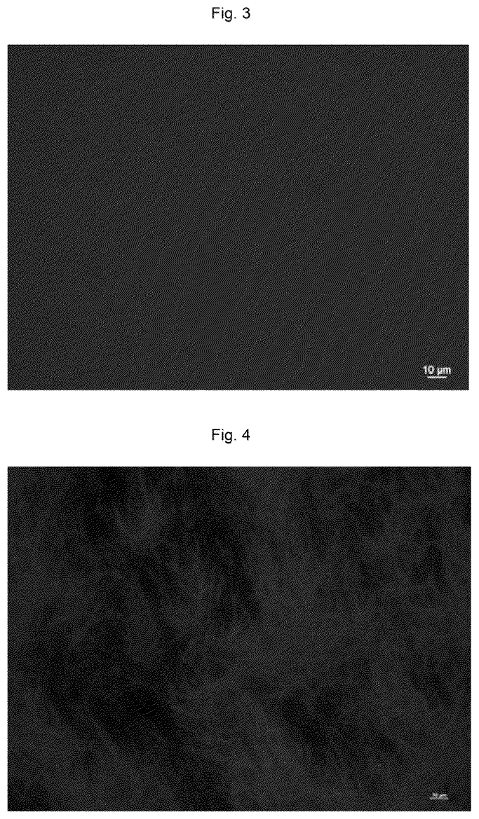

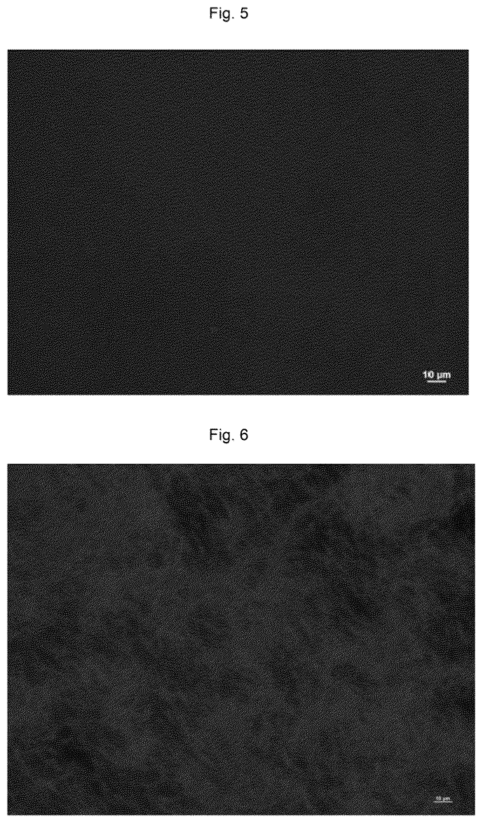

By comparing FIG. 1 and FIG. 2, FIG. 3 and FIG. 4, FIG. 5 and FIG. 6, it can be seen that the luminescence uniformity of the electroluminescent device made of the conductive film by the embodiment of the disclosure was improved obviously. However, for the electroluminescent device made of conductive films in the prior art in the comparative example, the obvious silver nanowire aggregation phenomenon could be observed. In addition, under the condition that the solid content and fabrication process of the conductive film of Example 10 to 12 and Comparative Examples 4 to 6 were the same, the distribution uniformity of silver nanowires in the conductive film of the example was improved, resulting in smaller sheet resistance and higher light transmittance of the conductive film, and thus higher external quantum efficiency of the electroluminescence device.

The above is only preferred embodiments of the disclosure and is not intended to limit the disclosure. Those skilled in the art may make various modifications and variations. Any modifications, equivalent replacements, improvements and the like made within the spirit and principle of the disclosure shall fall within the scope of protection of the disclosure.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A device containing a conductive film, the conductive film comprising a first conductive material and a second conductive material, the first conductive material comprises a first conductor and a first ligand coating the surface of the first conductor, the second conductive material comprises a second conductor and a second ligand coating the surface of the second conductor, and the first ligand and the second ligand have mutually exclusive affinities to water.

13. The device according to claim 12, comprising a first electrode, a functional layer and a second electrode which are sequentially stacked, and the first electrode and/or the second electrode comprise/comprises the conductive film.

14. The device according to claim 13, wherein the functional layer has a first functional layer close to the first electrode and a second functional layer close to the second electrode, and the device has at least one of characteristic A and characteristic B: A, the conductive film of the first electrode and the first functional layer are embedded with each other; B, the conductive film of the second electrode and the second functional layer are embedded with each other.

15. The device according to claim 13, wherein the conductive film of the first electrode and/or the second electrode is disposed adjacent to the functional layer.

16. The device according to claim 13, wherein the first electrode is composed of the conductive film and a bottom electrode material.

17. The device according to claim 12, comprising a carrier transport layer, part of the material of the carrier transport layer is embedded in the conductive film, and part of the surface of the conductive film is covered by the carrier transport layer.

18. Anink formulation, comprising a first ink and a second ink, the first ink comprises a first conductive material and a first solvent, the second ink comprises a second conductive material and a second solvent, the first conductive material comprises a first conductor and a first ligand coating the surface of the first conductor, the second conductive material comprises a second conductor and a second ligand coating the surface of the second conductor, and the first ligand and the second ligand have mutually exclusive affinities to water.

19. The ink formulation according to claim 18, wherein the solid content of the conductive material of the first ink and the second ink is independently 0.01 wt % to 10 wt %.

20. The ink formulation according to claim 18, wherein the mass of the first ligand accounts for 0.1% to 10% of the total mass of the first conductive material; and the mass of the second ligand accounts for 0.1% to 10% of the total mass of the second conductive material.

21. The ink formulation according to claim 18, wherein the weight ratio of the first conductive material to the second conductive material is 1:10 to 10:1.

22. The ink formulation according to claim 18, wherein the surface tension of the first ink is 30 to 70 mN/m, and the surface tension of the second ink is 20 to 40 mN/m.

23. The ink formulation according to claim 18, wherein the first conductor and the second first conductor are metal nanowires.

24. The ink formulation according to claim 18, wherein the first ligand and the second ligand are respectively independently selected from one or more of a nanoparticle ligand, an organic small molecule ligand and a polymer ligand.

25. The ink formulation according to claim 24, wherein the nanoparticle ligand is an inorganic nanoparticle ligand or an organic nanoparticle ligand, the inorganic nanoparticle ligand is selected from at least one of inorganic salts, metal oxide particles, metal particles and SiO₂ nanospheres, and the organic nanoparticle ligand is selected from at least one of micelle microspheres and polymer microspheres.

26. The ink formulation according to claim 24, wherein the structural formula of the organic small molecule ligand is X-Y, X is used to coordinate with the surface of the first conductor or the second conductor, the structure of Y comprises a hydrophilic group or a hydrophobic group, the hydrophilic group is selected from at least one of a hydroxyl group, a carboxyl group, an aldehyde group, an amino group, an amine group, a sulfonic group and a sulfinyl group, and a hydrophobic group is selected from at least one of a saturated aliphatic group, an unsaturated aliphatic group, halogen, an aromatic hydrocarbon group, an ester group and a nitro group.

27. The ink formulation according to claim 24, wherein the polymer ligand is selected from one or more of PVP, PEO, PEG, FIB, PVK, PVB, PSS, cycloolefin copolymer and fluorine-containing resin.

28. (canceled)

29. (canceled)

30. (canceled)

31. (canceled)

32. (canceled)

33. (canceled)

34. (canceled)

35. (canceled)

36. The device according to claim 12, wherein the first conductor and the second first conductor are metal nanowires.

37. The device according to claim 12, wherein the weight ratio of the first conductive material to the second conductive material is 1:10 to 10:1.

38. The device according to claim 12, wherein the mass of the first ligand accounts for 0.1% to 10% of the total mass of the first conductive material; and the mass of the second ligand accounts for 0.1% to 10% of the total mass of the second conductive material.

39. The device according to claim 36, wherein the metal nanowires are silver nanowires, the diameter of each silver nanowire is 10 to 100 nm, and the length of each silver nanowire is 10 to 100 μm.

40. The device according to claim 12, wherein the first ligand and the second ligand are respectively independently selected from one or more of a nanoparticle ligand, an organic small molecule ligand and a polymer ligand.

41. The device according to claim 40, wherein the nanoparticle ligand is an inorganic nanoparticle ligand or an organic nanoparticle ligand, the inorganic nanoparticle ligand is selected from at least one of inorganic salts, metal oxide particles, metal particles and SiO₂ nanospheres, and the organic nanoparticle ligand is selected from at least one of micelle microspheres and polymer microspheres.

42. The device according to claim 40, wherein the structural formula of the organic small molecule ligand is X-Y, X is used to coordinate with the surface of the first conductor or the second conductor, the structure of Y includes a hydrophilic group or a hydrophobic group, the hydrophilic group is selected from at least one of a hydroxyl group, a carboxyl group, an aldehyde group, an amino group, an amine group, a sulfonic group and a sulfinyl group, and a hydrophobic group is selected from at least one of a saturated aliphatic group, an unsaturated aliphatic group, halogen, an aromatic hydrocarbon group, an ester group and a nitro group.

43. The device according to claim 40, wherein the polymer ligand is selected from one or more of PVP, PEO, PEG, FIB, PVK, PVB, PSS, cycloolefin copolymer and fluorine-containing resin.

44. The device according to claim 36, wherein a sheet resistance of the conductive film is ≤500 Ω/□.

45. The device according to claim 44, wherein a visible light transmittance of the conductive film is ≥70%.
